(19) United States
(12) Patent Application Publication
(10) Pub. No.: US 2019/0147353 A1
(43) Pub. Date: May 16, 2019

(54) WATCHED HYPOTHESIS FOR DEEP QUESTION ANSWERING

(71) Applicant: International Business Machines Corporation, Armonk, NY (US)

(72) Inventors: Charles E. Beller, Baltimore, MD (US); William G. Dubyak, Potomac, MD (US); Palani Sakthi, Palatine, IL (US); Kristen M. Summers, Takoma Park, MD (US)

(21) Appl. No.: 15/813,363

(22) Filed: Nov. 15, 2017

(51) Int. Cl. G06N 5/04; G06F 17/30

(52) U.S. Cl. CPC G06N 5/041; G06F 17/3005; G06F 17/30026; G06F 17/30448

(57) ABSTRACT

In an approach to watching hypotheses in a deep question answering system, one or more processors receive a question from a user and generate a first result set based on the question. One or more processors receive a request from the user to watch one or more hypothesis answers in the first result set. One or more processors generate a second result set based on the question, where the second result set is generated at a later time than the first result set. One or more processors further determine a similarity score between a hypothesis answer in the second set of one or more hypothesis answers and the watched one or more hypothesis answers and, responsive to determining that the similarity score is below a predetermined threshold, one or more processors send a contradiction alert to the user indicating a potential alternative hypothesis.

### BACKGROUND OF THE INVENTION

The present invention relates generally to the field of question answering, and more particularly to watching hypotheses in a deep question answering system.

In information retrieval and natural language processing, a question answering (QA) system refers to a system capable of automatically producing answers to natural language questions. A deep QA system, in turn, uses artificial intelligence (AI) analysis over multiple information sources, including text-based and knowledge-based resources, to formulate answers for a question.

### SUMMARY

Embodiments of the present invention disclose a method, a computer program product, and a system for watching hypotheses in a deep QA system. The method may include, responsive to receiving a question from a user, one or more processors generating a first result set based on the question, the first result set including a first set of one or more hypothesis answers. The method may also include, responsive to receiving a request from the user to watch one or more hypothesis answers in the first result set, one or more processors generating a second result set based on the question, the second result set including a second set of one or more hypothesis answers and the second result set being generated at a later time than the first result set. The method may additionally include one or more processors determining a similarity score between a hypothesis answer in the second set of one or more hypothesis answers and the watched one or more hypothesis answers and, responsive to determining that the similarity score is below a predetermined threshold, one or more processors sending a contradiction alert to the user indicating a potential alternative hypothesis.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a deep QA program for submitting a question and storing a watch hypothesis, in accordance with an embodiment of the present invention;

FIG. 3 is a flowchart depicting operational steps of a deep QA program for re-submitting a question and obtaining at least one new hypothesis, in accordance with an embodiment of the present invention;

FIG. 4 depicts a block diagram of components of the server computer executing the user identification program within the distributed data processing environment of FIG. 1, in accordance with an embodiment of the present invention.

### DETAILED DESCRIPTION

Current deep QA systems are able to designate watched questions. For example, a user may request to be alerted if the result set for an input question changes. The present invention provides an extension to these basic watched questions by providing functionality to record a user approved hypothesis and alert the user only if the user approved hypothesis is contradicted by another hypothesis. This finer grained input allows for more valuable alert functionality, amongst other benefits.

Implementation of embodiments of the present invention may take a variety of forms, and exemplary implementation details are discussed subsequently with reference to the Figures.

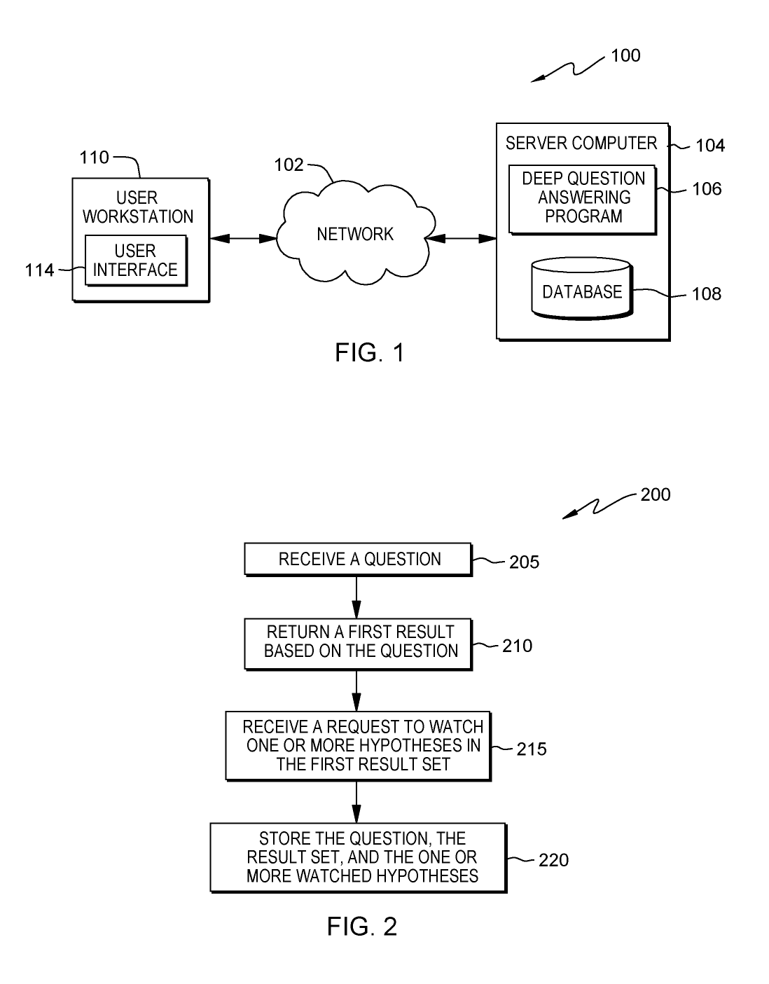

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and user workstation 110, all interconnected over network 102.

In general, network 102 can be any combination of connections and protocols that will support communications between server computer 104 and user workstation 110, and other computing devices (not shown) within distributed data processing environment 100. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that can receive and transmit data, voice, and/or video signals, including multimedia signals that include voice, data, and video information.

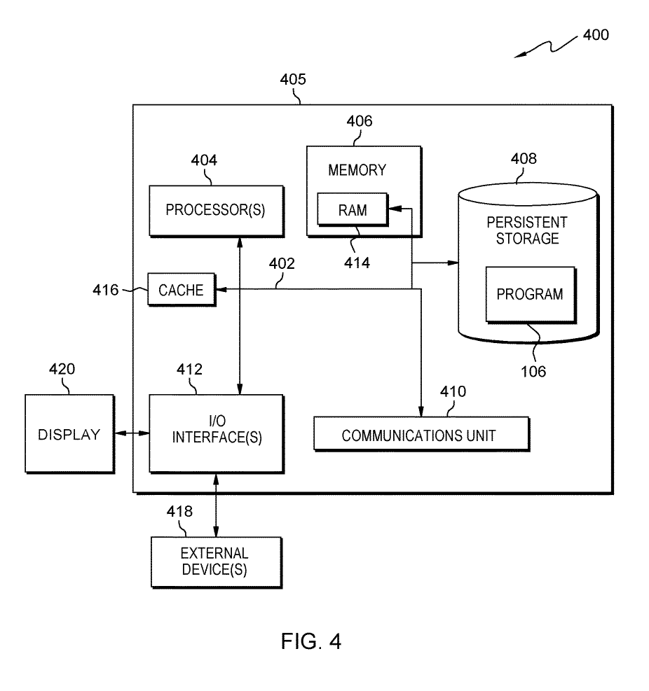

Server computer 104 can be a standalone computing device, a management server, a content service, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any other programmable electronic device capable of communicating with user workstation 110, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 may include internal and external hardware components, as depicted and described in further detail with respect to FIG. 4.

Server computer 104 includes deep QA program 106 for watching hypotheses and evidence passages in relation to a submitted question. In this context, a hypothesis is a candidate answer for a question posed by a user of deep QA program 106 and an evidence passage may be a document or a portion of a document that supports a hypothesis. Deep QA program 106 is an artificial intelligence application executing on data processing hardware that answers questions pertaining to a given subject-matter domain presented in natural language. Deep QA program 106 provides hypotheses and evidence passages by analyzing one or more natural language inputs from various sources including a corpus of electronic documents or other data, data from a content creator, information from one or more content users, and other such inputs from other possible sources of input. Data storage devices store the corpus of data. A content creator creates content in a document for use as part of a corpus of data with the deep QA program 106. The document may include any file, text, article, or source of data for use in the deep QA program 106. For example, deep QA program 106 accesses a body of knowledge about the domain, or subject matter area (e.g., financial domain, medical domain, legal domain, etc.) where the body of knowledge (knowledgebase) can be organized in a variety of configurations, e.g., a structured repository of domain-specific information, such as ontologies, or unstructured data related to the domain, or a collection of natural language documents about the domain.

Content users input questions to the server computer 104 which implements the deep QA program 106. Deep QA program 106 provides an answer to the input questions using the content in the corpus of data by evaluating documents, sections of documents, portions of data in the corpus, or the like. When a process evaluates a given section of a document for semantic content, the process can use a variety of conventions to query such document from the deep QA program 106, e.g., sending the query to the deep QA program 106 as a well-formed question which is then interpreted by the deep QA program 106 and a response is provided containing one or more answers to the question.

In some embodiments of the present invention, deep QA program 106 receives a question and finds a first result set based on the question. The first result set includes one or more hypotheses (i.e., one or more possible answers to the submitted question). The result set may also include one or more evidence passages that support the one or more hypotheses. Deep QA program 106 further receives a request from a user to watch one or more hypotheses. Deep QA program 106 watches a hypothesis by periodically re-submitting the question and obtaining a second result set. Deep QA program 106 compares the second result set with the watched hypothesis. If at least one hypothesis in the second result set is sufficiently dissimilar from the watched hypothesis, deep QA program 106 stores the second result set and sends a notification that there is a new hypothesis for review.

Database 108 is a repository for data used by deep QA program 106. Data used by deep QA program 106 may include result sets based on questions submitted to the deep QA program 106. The result sets stored in database 108 may include one or more hypothesis and one or more evidence passages supporting each hypothesis of the one or more hypothesis. In the depicted embodiment, database 108 resides on server computer 104. In another embodiment, database 108 may reside elsewhere within distributed data processing environment 100 provided deep QA program 106 has access to database 108.

User workstation 110 enables a user to access deep QA program 106 to submit a question and watch one or more specific hypotheses or the evidence passages that support those hypotheses. In some embodiments of the present invention, user workstation 110 is a device that performs programmable instructions. For example, user workstation 110 can be a laptop computer, a tablet computer, a smart phone, or any programmable electronic mobile device capable of communicating with various components and devices within distributed data processing environment 100, via network 102. In general, user workstation 110 represents any programmable electronic mobile device or combination of programmable electronic mobile devices capable of executing machine readable program instructions and communicating with other computing devices (not shown) within distributed data processing environment 100 via a network, such as network 102. User workstation 110 includes an instance of user interface 112.

User interface 112 provides an interface to deep QA program 106 on server computer 104 for a user of user workstation 110. In some embodiments of the present invention, user interface 112 may be a graphical user interface (GUI) or a web user interface (WUI) and can display text, documents, web browser windows, user options, application interfaces, instructions for operation, and include the information (such as graphic, text, and sound) that a program presents to a user and the control sequences the user employs to control the program. In other embodiments, user interface 112 may also be mobile application software that provides an interface between a user of user workstation 110 and server computer 104. Mobile application software, or an “app,” is a computer program designed to run on smart phones, tablet computers and other mobile devices. User interface 112 enables the user of user workstation 110 to register a mac address and time period for an IoT device. In accordance with some embodiments, users register a mac address and time period for an IoT device by interaction with user interface 112, which may include touch screen devices, audio capture devices, and other types of user interfaces. In other embodiments, user interface 112 may be an external device operatively connected to user workstation 110 via near-field communication or other types of wired and/or wireless technologies.

Deep QA program 106 is depicted and described in further detail with respect to FIG. 2. Referring to flowchart 200, deep QA program 106 receives a question and finds a first result set based on the question. The first result set includes one or more hypotheses and one or more evidence passages that support the one or more hypotheses. Deep QA program 106 further stores the first result set.

Processing begins at operation 205, where deep QA program 106 receives a question. In some embodiments of the present invention, deep QA program 106 provides a platform where one or more users can log in to submit questions. In some embodiments, deep QA program 106 provides an application programming interface (API) for users to submit questions. In an exemplary embodiment of this invention, a user named Ben utilizes user workstation 110 to log in to deep QA program 106. Ben is an end-user of deep QA program 106. In this example, Ben submits the following question: “What is the most popular household pet?”

Processing continues at operation 210, where deep QA program 106 returns a first result set based on the question including a ranked set of hypotheses and a ranked set of evidence passages. In some embodiments of the present invention, deep QA program 106 parses the question to extract the major features of the question, uses the extracted features to formulate queries, and then applies those queries to a corpus of data. Based on the application of the queries to the corpus of data, deep QA program 106 generates a set of hypotheses, or candidate answers to the input question, by looking across the corpus of data for portions of the corpus of data that have some potential for containing a valuable response to the input question. Deep QA program 106 may then perform deep analysis on the language of the input question and the language used in each of the portions of the corpus of data found during the application of the queries using a variety of reasoning algorithms (e.g., comparisons, natural language analysis, lexical analysis, or the like), and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

Continuing the exemplary embodiment, deep QA program 106 returns a first result set with hypothesis “dog” and supporting evidence passage as follows: “The most popular pets are likely dogs and cats but people also keep house rabbits, and other small animals as pets.”

Processing proceeds at operation 215, where deep QA program 106 receives a request to watch one or more hypotheses in the first result set. In some embodiments of the present invention, the request to watch one or more hypotheses in the ranked set of hypotheses may further include a request to watch one or more evidence passages from the ranked set of evidence passages. In some embodiments, a watched hypothesis includes: (i) a question, i.e. the initial user query; (ii) a hypothesized answer to that question; and (iii) one or more passages providing evidence for that hypothesis, where each passage is associated with a document the system has ingested. In some embodiments, the watched hypothesis is selected by indicating in a user interface, or via an API call, the hypothesis of interest in combination with one or more evidence passages that provide evidence for that hypothesis.

In some embodiments, deep QA program 106 may receive a hypothesis statement and a document that provides evidence for that hypothesis statement. In some embodiments, the hypothesis statement can then be transformed into a question-answer yielding a first result set. In some embodiments, evidence passages can be derived from the document by taking text spans of some size surrounding text that matches the hypothesis statement. In some embodiments, hypotheses can be expanded by consulting a thesaurus or synonym resource.

In the exemplary embodiment, Ben logs into deep QA program 106 via user workstation 110 and selects the hypothesis “dog” as a watched hypothesis.

Processing continues at operation 220, where deep QA program 106 stores the question, the first result set, and the one or more watched hypotheses in a stored result set. In the exemplary embodiment, deep QA program 106 stores the question (i.e., “what is the most popular household pet?”), the first result set, and the watched hypothesis (i.e., “dog”) in database 108.

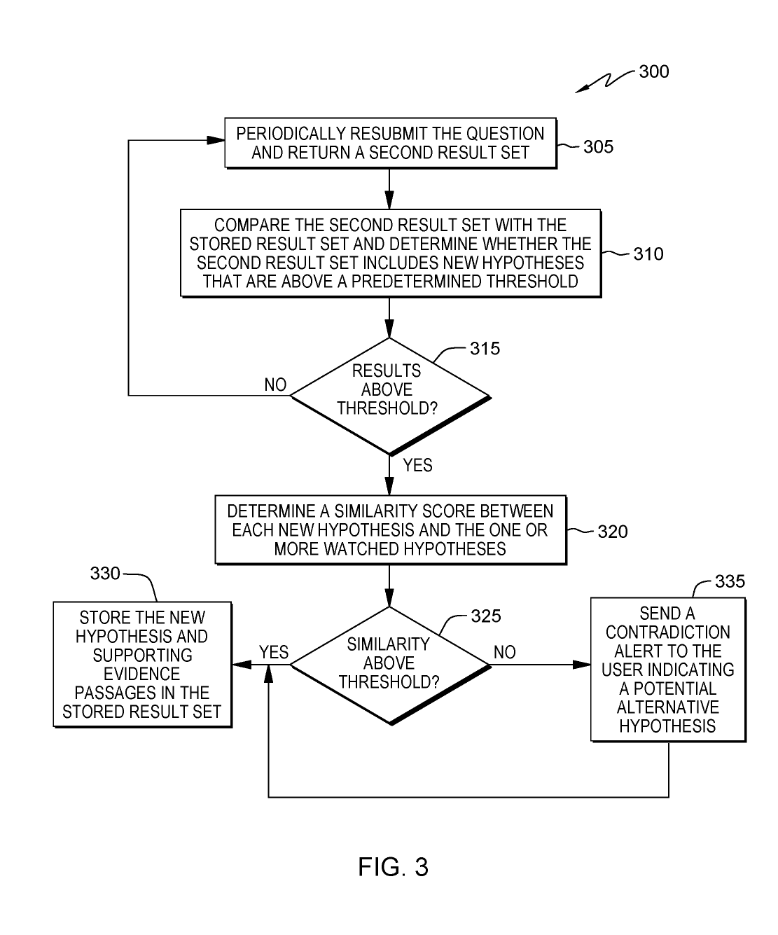

Deep QA program 106 is depicted and described in further detail with respect to FIG. 3. Referring to flowchart 300, deep QA program 106 periodically resubmits the watched hypothesis and obtains a new result set. If the new result set contains a hypothesis that contradicts the watched hypothesis, a notification is sent to the user.

Processing begins at operation 305, where deep QA program 106 resubmits the question periodically and returns a second result set. In some embodiments of the present invention, the second result set includes a ranked set of hypotheses and a ranked set of evidence passages. In some embodiments, the periodicity of re-submission can be configurable based on the rate of change of the text corpus (e.g., daily or weekly).

Continuing the exemplary embodiment, deep QA program 106 resubmits the question “what is the most popular household pet?” weekly. Deep QA program 106 returns a second result set with hypothesis “cat” and supporting evidence passage as follows: “Here in the U.S., slightly more households own dogs than cats. However, statistics show that the raw worldwide population of cats exceeds that of dogs by 2 million.”

Processing continues at operation 310, where deep QA program 106 compares the second result set with the stored result set and determine whether the second result set includes hypotheses that are above a predetermined threshold. In some embodiments, deep QA program 106 generates and scores hypotheses for the re-submitted question. In some embodiments, scores are routinely calculated by one or more machine learning models and interpreted as the probability that the answer is correct (e.g., P(Y=1)).

In some embodiments of the present invention, deep QA program 106 evaluates whether the second result set includes hypotheses that are above a predetermined threshold to eliminate incorrect and/or imprecise answers. In some embodiments, the predetermined threshold is arbitrarily set to 50%. In some embodiments, a user may configure the predetermined threshold to fit the requirements in a particular application. For example, if deep QA program 106 is evaluating too many incorrect responses the user can adjust the predetermined threshold to reduce the number of incorrect responses being evaluated by deep QA program 106. In some embodiments of the present invention, if new passages are found that score highly enough they are added to the stored result set.

If the second result set does not include new hypotheses above a predetermined threshold (operation 315, “no” branch), processing continues at operation 305, where deep QA program 106 resubmits the question periodically. If the second result set includes new hypotheses above a predetermined threshold (operation 315, “yes” branch), processing continues at operation 330, where deep QA program 106 adds each new hypothesis above the predetermined threshold and its corresponding evidence passages to the stored result set.

In the exemplary embodiment, the new hypothesis “cat” is above the predetermined threshold. Accordingly, the new hypothesis and its corresponding supporting evidence passage are included in the stored result set.

Processing continues at operation 320, where deep QA program 106 determines a similarity score between each new hypothesis and the one or more watwched hypotheses. In some embodiments of the present invention, deep QA program 106 determines a similarity score between each hypothesis and the watched hypothesis (e.g., S_12=S(H1, H2)). In some embodiments, the similarity score may be obtained based on: (i) vector models (e.g., word2vec) or other distance metric; (ii) distance within a semantic resource or taxonomy (e.g., wordnet); (iii) string edit distance (e.g., Levenshtein distance); or (iv) any suitable combination of metrics.

In the exemplary embodiment, deep QA program 106 determines the path between the watched hypothesis (i.e., “dog”) and the new hypothesis (i.e., “cat”) in wordnet (e.g., cat-[direct hypernym]->feline-[sister term]->canine-[direct hyponym]->dog, length: 4, contradiction-indicating links: sister term). Deep QA program 106 further determines a length normalized Levenshtein distance ranging between 0 and 1, where 0 is the identity 1 is fully different (e.g., Lev_n_12=Lev(H1, H2)/(length(H1)+length(H2)), Lev(cat, dog)=3, len(cat)+len(dog)=3, Lev_n_12=1). Based on these results, deep QA program 106 determines that cat is sufficiently dissimilar to dog.

Processing proceeds at operation 325, where deep QA program 106 determines whether the similarity score between each new hypothesis and the watched hypothesis is above a predetermined threshold. If the similarity score between a new hypothesis and the watched hypothesis is above a predetermined threshold (operation 325, “yes” branch), processing continues at operation 330, where deep QA program 106 stores the new hypothesis and evidence passages supporting the new hypothesis in the stored result set.

If the similarity score between a new hypothesis and the watched hypothesis is not above a predetermined threshold (operation 325, “no” branch), processing continues at operation 335, where deep QA program 106 may send a contradiction alert to the user indicating a potential alternative hypothesis. In some embodiments of the present invention, deep QA program 106 may continue processing by storing the new hypothesis and evidence passages supporting the new hypothesis in the stored result set as per operation 330.

Continuing the exemplary embodiment, deep QA program 106 sends a message to Ben with a notification that there is a new hypothesis for his review. Ben logs into deep QA program 106 via user workstation 110 where he can see the new hypothesis (i.e., “cat”) and the supporting evidence for the new hypothesis.

FIG. 4 depicts a block diagram 400 of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computing device 405 and server computer 104 include communications fabric 402, which provides communications between computer processor(s) 404, memory 406, persistent storage 408, communications unit 410, and input/output (I/O) interface(s) 412.

Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Deep QA program 106 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of distributed data processing environment 100. In these examples, communications unit 410 includes one or more network interface cards. Communications unit 410 may provide communications through the use of either or both physical and wireless communications links. Deep QA program 106 may be downloaded to persistent storage 408 through communications unit 410.

I/O interface(s) 412 allows for input and output of data with other devices that may be accessible to computing device 405 and server computer 104, such as user workstation 110, and other computing devices (not shown). For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., deep QA program 106 can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, comprising:
responsive to receiving a question from a user, generating, by one or more processors, a first result set based on the question, wherein the first result set includes a first set of one or more hypothesis answers;
responsive to receiving a request from the user to watch one or more hypothesis answers in the first result set, generating, by one or more processors, a second result set based on the question, wherein the second result set includes a second set of one or more hypothesis answers, and wherein the second result set is generated at a later time than the first result set;
determining, by one or more processors, a similarity score between a hypothesis answer in the second set of one or more hypothesis answers and the watched one or more hypothesis answers; and
responsive to determining that the similarity score is below a predetermined threshold, sending, by one or more processors, a contradiction alert to the user indicating a potential alternative hypothesis.

2. The method of claim 1, wherein the watched hypothesis includes: (i) the question; (ii) a hypothesis answer; and (iii) one or more passages providing evidence for the hypothesis answer, where each passage is associated with an ingested document.

3. The method of claim 1, wherein the similarity score is determined by: (i) a vector model; (ii) a distance within a semantic taxonomy; (iii) a string edit distance; or (iv) any suitable combination of metrics.

4. The method of claim 1, wherein generating, by one or more processors, a first result set based on the question comprises:
parsing, by one or more processors, the question to extract one or more features of the question;
determining, by one or more processors, one or more queries based on the one or more features of the question; and
generating, by one or more processors, a first result set by querying a corpus of data based on the determined queries.

5. The method of claim 1, wherein receiving question from a user comprises:
receiving, by one or more processors, a hypothesis statement and one or more passages providing evidence for the hypothesis statement, where each passage is associated with an ingested document; and
determining, by one or more processors, a question by transforming the hypothesis statement into a question and hypothesis answer pair.

6. The method of claim 1, further comprising determining, by one or more processors, an expanded hypothesis answer by querying a thesaurus resource.

7. The method of claim 1, further comprising storing, by one or more processors, the hypothesis answer in the second set of one or more hypothesis answers and the watched one or more hypothesis answers.

8. A computer program product, comprising:
one or more computer readable storage devices and program instructions stored on the one or more computer readable storage devices, the stored program instructions comprising:
program instructions to, responsive to receiving a question from a user, generate a first result set based on the question, wherein the first result set includes a first set of one or more hypothesis answers;
program instructions to, responsive to receiving a request from the user to watch one or more hypothesis answers in the first result set, generate a second result set based on the question, wherein the second result set includes a second set of one or more hypothesis answers, and wherein the second result set is generated at a later time than the first result set;
program instructions to determine a similarity score between a hypothesis answer in the second set of one or more hypothesis answers and the watched one or more hypothesis answers; and
program instructions to, responsive to determining that the similarity score is below a predetermined threshold, send a contradiction alert to the user indicating a potential alternative hypothesis.

9. The computer program product of claim 8, wherein the watched hypothesis includes: (i) the question; (ii) a hypothesis answer; and (iii) one or more passages providing evidence for the hypothesis answer, where each passage is associated with an ingested document.

10. The computer program product of claim 8, wherein the similarity score is determined by: (i) a vector model; (ii) a distance within a semantic taxonomy; (iii) a string edit distance; or (iv) any suitable combination of metrics.

11. The computer program product of claim 8, wherein the program instructions to generate a first result set based on the question comprises:
program instructions to parse the question to extract one or more features of the question;
program instructions to determine one or more queries based on the one or more features of the question; and
program instructions to generate a first result set by querying a corpus of data based on the determined queries.

12. The computer program product of claim 8, wherein receiving question from a user comprises:
program instructions to receive a hypothesis statement and one or more passages providing evidence for the hypothesis statement, where each passage is associated with an ingested document; and
program instructions to determine a question by transforming the hypothesis statement into a question and hypothesis answer pair.

13. The computer program product of claim 8, further comprising program instructions to determine an expanded hypothesis answer by querying a thesaurus resource.

14. The computer program product of claim 8, further comprising program instructions to store the hypothesis answer in the second set of one or more hypothesis answers and the watched one or more hypothesis answers.

15. A computer system, comprising:
one or more computer processors;
one or more computer readable storage devices;
program instructions stored on the one or more computer readable storage devices for execution by at least one of the one or more computer processors, the stored program instructions comprising:
program instructions to, responsive to receiving a question from a user, generate a first result set based on the question, wherein the first result set includes a first set of one or more hypothesis answers;
program instructions to, responsive to receiving a request from the user to watch one or more hypothesis answers in the first result set, generate a second result set based on the question, wherein the second result set includes a second set of one or more hypothesis answers, and wherein the second result set is generated at a later time than the first result set;
program instructions to determine a similarity score between a hypothesis answer in the second set of one or more hypothesis answers and the watched one or more hypothesis answers; and
program instructions to, responsive to determining that the similarity score is below a predetermined threshold, send a contradiction alert to the user indicating a potential alternative hypothesis.

16. The computer system of claim 15, wherein the watched hypothesis includes: (i) the question; (ii) a hypothesis answer; and (iii) one or more passages providing evidence for the hypothesis answer, where each passage is associated with an ingested document.

17. The computer system of claim 15, wherein the similarity score is determined by: (i) a vector model; (ii) a distance within a semantic taxonomy; (iii) a string edit distance; or (iv) any suitable combination of metrics.

18. The computer system of claim 15, wherein the program instructions to generate a first result set based on the question comprises:
program instructions to parse the question to extract one or more features of the question;
program instructions to determine one or more queries based on the one or more features of the question; and
program instructions to generate a first result set by querying a corpus of data based on the determined queries.

19. The computer system of claim 15, wherein receiving question from a user comprises:
program instructions to receive a hypothesis statement and one or more passages providing evidence for the hypothesis statement, where each passage is associated with an ingested document; and
program instructions to determine a question by transforming the hypothesis statement into a question and hypothesis answer pair.

20. The computer system of claim 15, further comprising program instructions to determine an expanded hypothesis answer by querying a thesaurus resource.
